(19) United States
(12) Patent Application Publication
(10) Pub. No.: US 2024/0361556 A1
(43) Pub. Date: Oct. 31, 2024

(54) HIGH-PRECISION ALIGNABLE OPTICAL MOUNTING

(71) Applicant: KLA Corporation, Milpitas, CA (US)

(72) Inventors: Shreyas Bhaban, Fremont, CA (US); Santosh Kumar Sankar, San Jose, CA (US); Francis Chilese, San Ramon, CA (US)

(21) Appl. No.: 18/642,348

(22) Filed: Apr. 22, 2024

Related U.S. Application Data
(60) Provisional application No. 63/462,525, filed on Apr. 28, 2023.

(51) Int. Cl. G02B 7/00; G02B 7/02

(52) U.S. Cl. CPC G02B 7/004; G02B 7/02

(57) ABSTRACT

An optical assembly may include an optical element comprising a first surface. An optical assembly may include a mount comprising a first surface. An optical assembly may include a first transmissive layer. An optical assembly may include a first adhesive layer disposed between a first surface of the first transmissive layer and the first surface of the optical element. An optical assembly may include a second adhesive layer disposed between a second surface of the first transmissive layer and the first surface of the mount, wherein the first transmissive layer is configured to transmit illumination to the first adhesive layer and the second adhesive layer to cure the first adhesive layer and the second adhesive layer.

### CROSS-REFERENCE TO RELATED APPLICATION

The present application claims the benefit under 35 U.S.C. § 119 (e) of U.S. Provisional Application Ser. No. 63/462,525, filed Apr. 28, 2023, which is incorporated herein by reference in the entirety.

### TECHNICAL FIELD

The present disclosure relates to optical assemblies that include optical elements and corresponding mounts, and, in particular, to the implementation of one or more transmissive layers for directing illumination to adhesives for curing them in order to bond optical elements to the mounts.

### BACKGROUND

Optical elements within optical systems have mounting requirements for ensuring precise relative position and alignment (e.g., tip/tilt) between the optical element and one or more surfaces of a corresponding mount. Although the optical element can be mounted by mechanical means, such as clamping, precision optical systems often require adhesive bonding as a means to achieve higher precision positioning requirements.

The optical element and the mount may be bonded using optical adhesives, which are typically applied to a surface of either the optical element or the mount, or both. The optical adhesive is typically cured by exposure to light, such as ultraviolet light.

Because optical adhesives may include contaminates and are potentially outgassing, the amount of optical adhesive used in bonding may need to be reduced, which often comes at the cost of alignment accuracy and long-term reliability of the assembly. Particularly, these uncured adhesives tend to contaminate nearby surfaces in vacuum and/or at elevated temperatures. This trade-off is often difficult to balance where there are stringent requirements on allowed contamination levels, and optical element position precision. Also, because optical adhesives often require adequate exposure to light for curing, providing adequate light exposure to the adhesive may be difficult or impossible if one or more of the optical elements or the mount surfaces are opaque to light (e.g., ultraviolet light).

Therefore, there is a need for a method for adhering an optical element to a mount, where one or both of the optical element or mount is opaque to light, that cures the deficiencies of the previous approaches identified above.

### SUMMARY

An optical assembly is disclosed, in accordance with one or more embodiments of the present disclosure. In one embodiment, the optical assembly includes an optical element including a first surface. In another embodiment, the optical assembly includes a mount including a first surface. In another embodiment, the optical assembly includes a first transmissive layer. In another embodiment, the optical assembly includes a first adhesive layer disposed between a first surface of the first transmissive layer and the first surface of the optical element. In another embodiment, the optical assembly includes a second adhesive layer disposed between a second surface of the first transmissive layer and the first surface of the mount, wherein the first transmissive layer is configured to transmit illumination to the first adhesive layer and the second adhesive layer to cure the first adhesive layer and the second adhesive layer.

An optical system is disclosed, in accordance with one or more embodiments of the present disclosure. In one embodiment, the optical system includes an optical assembly. In another embodiment, the optical assembly includes an optical element including a first surface. In another embodiment, the optical assembly includes a mount including a first surface. In another embodiment, the optical assembly includes a first transmissive layer. In another embodiment, the optical assembly includes a first adhesive layer disposed between a first surface of the first transmissive layer and the first surface of the optical element. In another embodiment, the optical assembly includes a second adhesive layer disposed between a second surface of the first transmissive layer and the first surface of the mount, wherein the first transmissive layer is configured to transmit illumination to the first adhesive layer and the second adhesive layer to cure the first adhesive layer and the second adhesive layer.

A method for coupling an optical element to a mount is disclosed, in accordance with one or more embodiments of the disclosure. In one embodiment, the method includes applying a first adhesive layer to a first surface of the mount. In another embodiment, the method includes adhering a first surface of a first transmissive layer onto the first surface of the mount via the first adhesive layer. In another embodiment, the method includes applying a second adhesive layer to a second surface of the first transmissive layer; adhering a first surface of an optical element onto the second surface of the first transmissive layer via the second adhesive layer. In another embodiment, the method includes curing the first adhesive layer and the second adhesive layer by exposing a surface of the first transmissive layer to illumination, wherein the first transmissive layer transmits the illumination to the first adhesive layer and the second adhesive layer.

A method for coupling an optical element to a first surface of a mount and a second surface of the mount is disclosed, in accordance with one or more embodiments of the disclosure. In one embodiment, the method includes applying a first adhesive layer to the first surface of the mount. In another embodiment, the method includes applying a second adhesive layer to the second surface of the mount. In another embodiment, the method includes adhering a first surface of a first transmissive layer to the first surface of the mount via the first adhesive layer. In another embodiment, the method includes adhering a first surface of a second transmissive layer to the second surface of the mount via the second adhesive layer. In another embodiment, the method includes curing the first adhesive layer and the second adhesive layer by exposing the first transmissive layer and the second transmissive layer to illumination, wherein the illumination transmits through the first transmissive layer to the first adhesive layer, and transmits through the second transmissive layer to the second adhesive layer. In another embodiment, the method includes applying a third adhesive layer to a second surface of the first transmissive layer or a first surface of the optical element. In another embodiment, the method includes applying a fourth adhesive layer to a second surface of the second transmissive layer or the second surface of the optical element. In another embodiment, the method includes adhering the optical element to the second surface of the first transmissive layer and the second surface of the second transmissive layer via the third adhesive layer and the fourth adhesive layer. In another embodiment, the method includes curing the third adhesive layer and the fourth adhesive layer by exposing an exposed surface of the first transmissive layer and an exposed surface of the second transmissive layer to illumination, wherein the illumination transmits through the first transmissive layer to the third adhesive layer, and through the second transmissive layer to the fourth adhesive layer.

It is to be understood that both the foregoing general description and the following detailed description are exemplary and explanatory only and are not necessarily restrictive of the invention as claimed. The accompanying drawings, which are incorporated in and constitute a part of the specification, illustrative embodiments of the invention and together with the general description, serve to explain the principles of the invention.

### BRIEF DESCRIPTION OF THE DRAWINGS

The numerous advantages of the disclosure may be better understood by those skilled in the art by reference to the accompanying figures.

FIGS. 1A-1B illustrate simplified schematic views of an optical assembly that includes an optical element adhered to a mount, in accordance with one or more embodiments of the disclosure.

FIG. 2A-2B illustrate simplified schematic views of an optical assembly that includes an optical element adhered to a mount at two mount surfaces, in accordance with one or more embodiments of the disclosure.

FIG. 3 illustrates a simplified schematic view of an optical system that includes an optical assembly, in accordance with one or more embodiments of the disclosure.

FIG. 4 illustrates a process flow diagram depicting a method for securing an optical element to a surface of a mount, in accordance with one or more embodiments of the disclosure.

FIG. 5A illustrate a process flow diagram depicting a method for securing an optical element to two surfaces of a mount, in accordance with one or more embodiments of the disclosure.

FIGS. 5B-5C illustrate simplified schematic views of steps of the method depicted in FIG. 5A, in accordance with one or more embodiments of the disclosure.

### DETAILED DESCRIPTION

Reference will now be made in detail to the subject matter disclosed, which is illustrated in the accompanying drawings. The present disclosure has been particularly shown and described with respect to certain embodiments and specific features thereof. The embodiments set forth herein are taken to be illustrative rather than limiting. It should be readily apparent to those of ordinary skill in the art that various changes and modifications in form and detail may be made without departing from the spirit and scope of the disclosure.

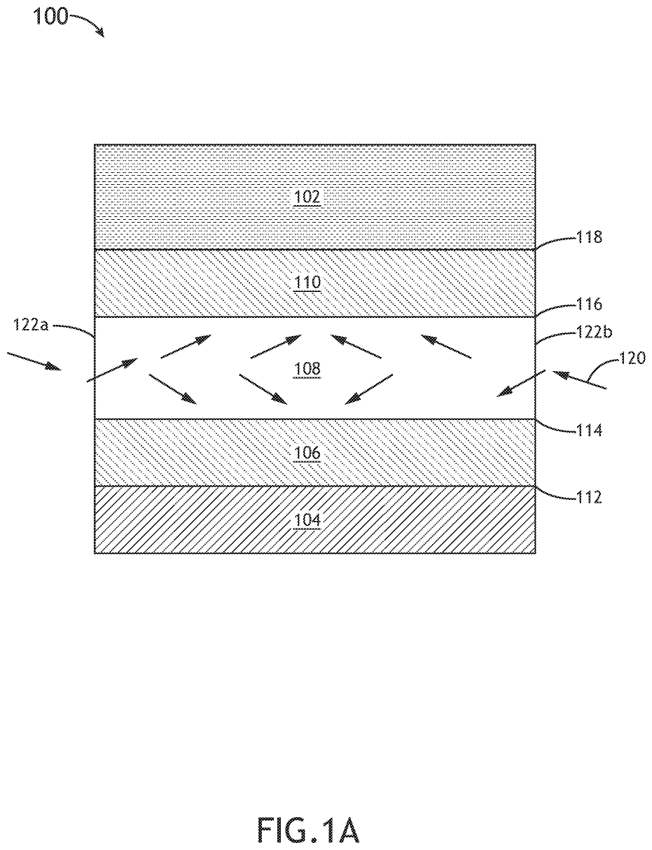

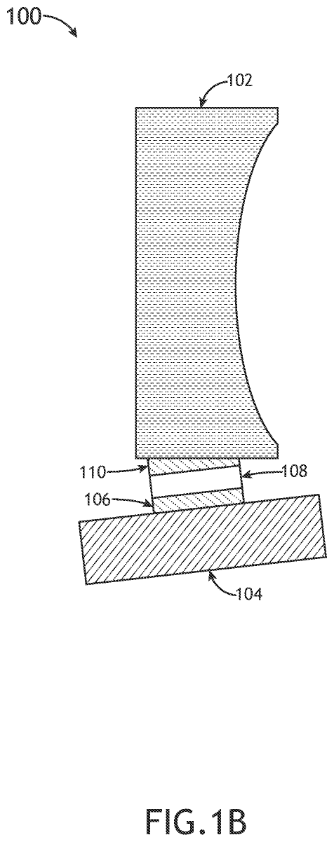

FIGS. 1A through 5C illustrate an optical assembly including an optical element adhered to a mount and a method of forming the optical assembly, in accordance with one or more embodiments of the present disclosure.

Embodiments of the present disclosure are directed to use of adhesive layers combined with a light transmissive layer to adhere an optical element to the mount. Upon adhering the optical element to the mount, the adhesive in the adhesive layers is cured via light entering through the transmissive layer. The method is particularly useful for bonding optical elements and mounts that are opaque to light.

FIGS. 1A and 1B illustrate simplified schematic views of an optical assembly 100, in accordance with one or more embodiments of the present disclosure.

In embodiments, the optical assembly 100 includes an optical element 102 adhered to a mount 104 via a first adhesive layer 106, a first transmissive layer 108 and a second adhesive layer 110. In embodiments, the first adhesive layer 106 is disposed upon (e.g., applied to) a first surface 112 of the mount 104. In embodiments, a first surface 114 of the first transmissive layer 108 (e.g., a transparent layer) is disposed upon the first adhesive layer 106. In embodiments, the second adhesive layer 110 is disposed upon a second surface 116 of the first transmissive layer 108. In embodiments, the optical element 102 is disposed upon the second adhesive layer 110 at a first surface 118. As shown in FIG. 1B, the optical element 102 may be tilted relative to the mount 104 as part of the alignment process, with the first adhesive layer 106, the first transmissive layer 108, and the second adhesive layer 110 securing the optical element 102 to the mount 104 in the tilted position.

In embodiments, the mount 104 may include any structural element or device that can be bonded to the optical element including, but not limited to, an optical mount. In embodiments, the optical element 102 may include any optical element in the art of optics including, but not limited to, a mirror, a lens, a prism, a polarizer, a filter, a grating, a beam splitter, or a window.

In embodiments, the adhesive layers include any type of adhesive including, but not limited to, epoxy adhesives, polyurethane adhesives, polyimide adhesives, cyanoacrylate adhesives, and acrylic adhesives. Different types of adhesives may be used in different layers (e.g., first adhesive layer 106 and second adhesive layer 110). For example, the first adhesive layer 106 may include a first adhesive (e.g., a metal-optimized adhesive) for bonding the first surface 114 of the first transmissive layer 108 to the first surface 112 of the mount 104. In another example, the second adhesive layer 110 may include a second adhesive (e.g., a glass-optimized adhesive) for binding the second surface 116 of the first transmissive layer 108 to the first surface 118 of the optical element 102.

In embodiments, one or more of the adhesives are cured using light. For example, the one or adhesives may include adhesives that are cured by ultraviolet light, visible light, and/or infrared light.

In embodiments, the first surface 118 of the optical element 102 or the first surface 112 of the mount 104 are opaque to light. For example, the first surface 118 of the optical element 102 and/or the first surface of the mount 104 may be opaque to ultraviolet and/or visible light, as shown in FIG. 1A. As a result, light necessary for curing the first and/or second adhesive layers 106, 110 will not pass through the first surface 118 of the optical element 102 and/or the first surface of the mount 104.

In embodiments, the first transmissive layer 108 includes one or more exposed surfaces 122a-b that are transparent to entry of light (e.g., ultraviolet light) into the first transmissive layer 108. The light that enters the first transmissive layer 108 can then be transmitted through the first surface 114 of the first transmissive layer 108 and the second surface 116 of the first transmissive layer 108 to the respective first adhesive layer 106 and second adhesive layer 110, thereby curing the adhesive in the first adhesive layer 106 and the second adhesive layer 110. Exposing the first transmissive layer 108 at the one or more exposed surfaces 122a-b solves the problem of curing the adhesive when light needed to cure the adhesive cannot effectively pass through the mount 104, the optical element 102, or the lengths of the first adhesive layer 106 and the second adhesive layer 110.

The first transmissive layer 108 may include any material or form that can enable the transmission of light (e.g., ultraviolet light) from the exposed surfaces 122a-b of the first transmissive layer 108 to the first adhesive layer 106 and the second adhesive layer 110. For example, the first transmissive layer 108 may include, but is not limited to, glass, plastic, or optical fibers. The first transmissive layer 108 may include any form. For example, the first transmissive layer 108 may include, but is not limited to, one or more prisms (e.g., a glass prism). By way of another example, the first transmissive layer 108 may include a matrix of transmissive and non-transmissive/reflective materials. For instance, the first transmissive layer 108 may include one or more materials or structures that guide the incoming light coming in from the exposed surfaces 122a-b toward the first surface 114 of the first transmissive layer 108 and the second surface 116 of the first transmissive layer 108, where the light is then transmitted through to the respective first adhesive layer 106 and the second adhesive layer 110.

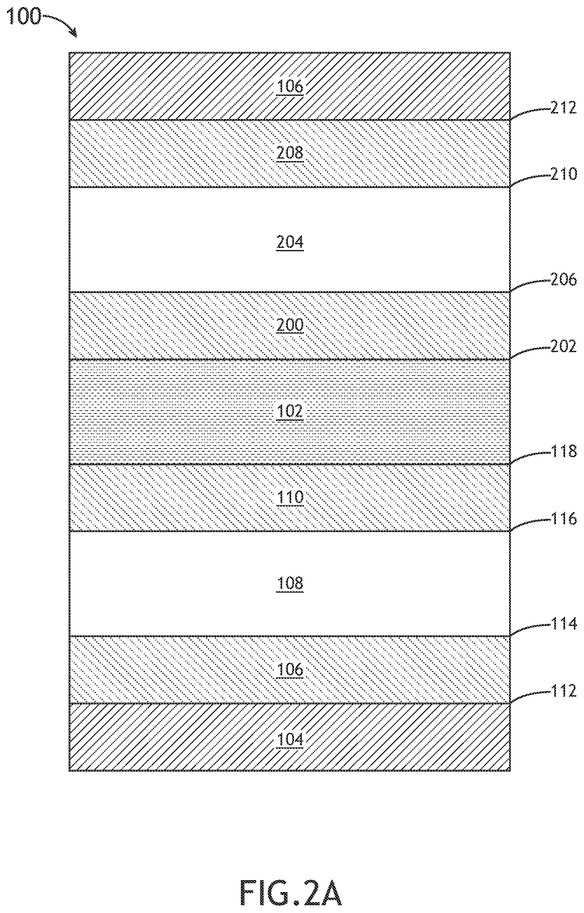

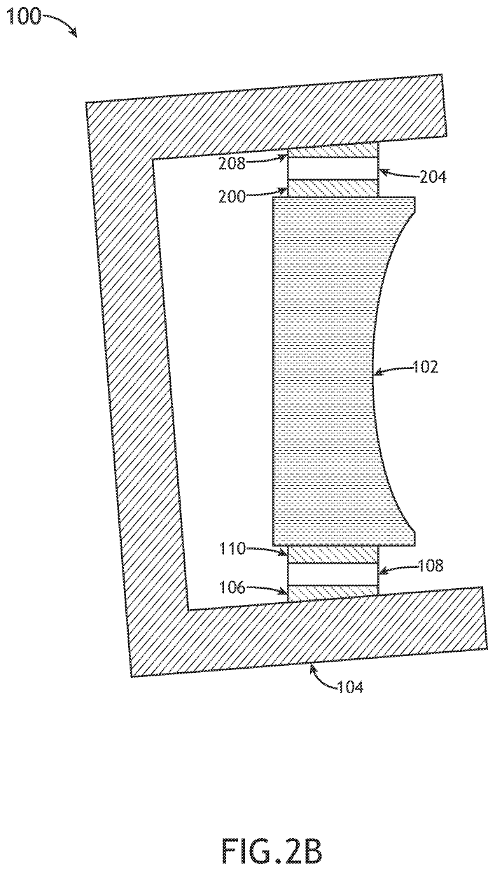

FIGS. 2A and 2B depict the optical element 102 coupled to the mount 104 at multiple contact points, in accordance with one or more embodiments of the disclosure. It is noted that the previous embodiments as described in the context of FIGS. 1A-1B should be interpreted to extend to FIGS. 2A-2B. In embodiments, For example, the optical element 102 may be coupled or adhered to the mount 104 utilizing multiple sets of adhesives and transmissive layers 108. For example, a third adhesive layer 200 may be disposed on a second surface 202 of the optical element 102. A second transmissive layer 204 may be disposed upon the third adhesive layer 200 at a first surface 206. A fourth adhesive layer 208 may be disposed upon a second surface 210 of the second transmissive layer 204. A second surface 212 of the mount may be disposed on, or adhered to, the fourth adhesive layer 208.

In embodiments, the method and optical assembly 100 described herein may include more than two contact points, (e.g., using more than two transmissive layers 108, 204). For example, the method and optical assembly may include more 3, 4, 5, 6, 7, 8, 9, or 10 or more contacts requiring a corresponding set of adhesive layers and transmissive layers. In embodiments, the mount 104 may include two or more separatable components or sub-components. For example, the mount 104 may include a first sub-component corresponding to the first surface 112 of the mount 104 and a second sub-component corresponding to the second surface 324 of the mount.

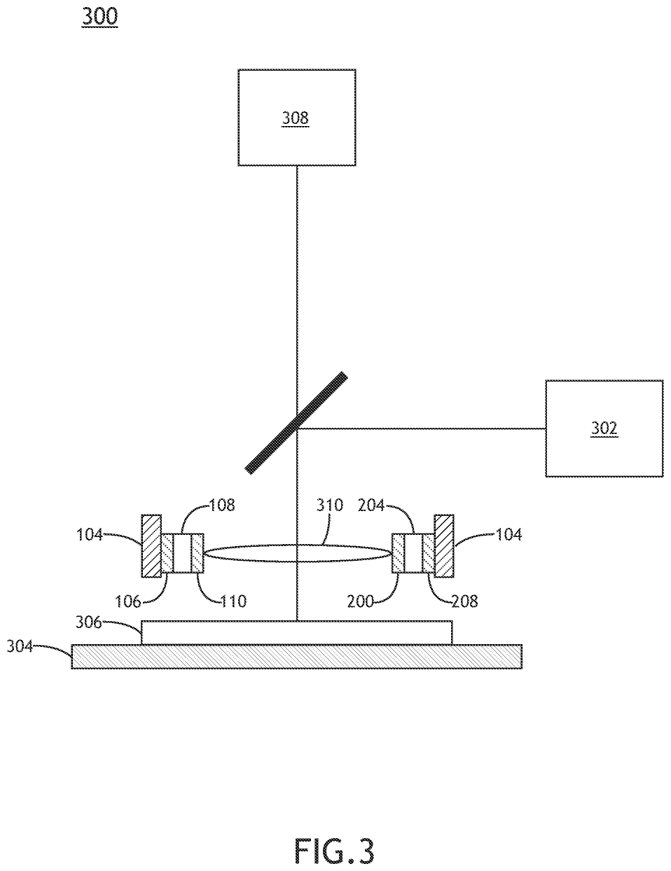

FIG. 3 illustrates a block diagram of an optical system 300, in accordance with one or more embodiments of the present disclosure. In embodiments, the optical system 300 incorporates the optical assembly 100 of the present disclosure. In embodiments, the optical system 300 includes a light source 302, a stage 304 for securing a sample 306, and one or more detectors 308. The optical system 300 may include any optical system known in the art. For example, the optical system 300 may include, but is not limited to, a semiconductor inspection system or a semiconductor metrology system. The optical assembly 100 as described previously herein may be utilized to secure one or more optical elements within the optical system 300. For example, the optical assembly 100 may be utilized to secure an objective 310. It is noted that system 300 is not limited to an objective and it is recognized herein that the optical assembly 100 and the method of forming the optical assembly 100 may be implemented to secure any optical element known in the art.

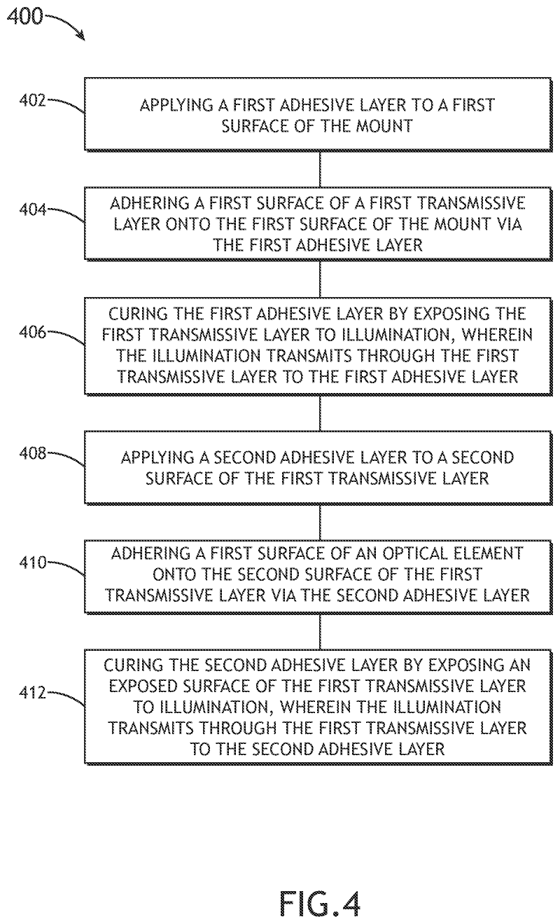

FIG. 4 illustrates a process flow diagram depicting a method 400 of coupling an optical element to a mount, in accordance with one or more embodiments of the disclosure.

In embodiments, the method 400 includes a step 402 of disposing (e.g., applying) a first adhesive layer 106 to the first surface 112 of the mount 104. In embodiments, the method includes a step 404 of adhering the first surface 114 of the first transmissive layer 108 onto the first surface 112 of the mount 104 via the first adhesive layer 106. In embodiments, the method 400 includes a step 406 of curing the first adhesive layer 106 by exposing the first transmissive layer 108 to illumination, wherein the illumination transmits through the first transmissive layer 108 to the first adhesive layer 106. In embodiments, the method 400 includes a step 408 of applying a second adhesive layer 110 to a second surface 116 of the first transmissive layer 108. In embodiments, the method 400 includes a step 410 of adhering the first surface 118 of the optical element 102 onto the second surface 116 of the first transmissive layer 108 via the second adhesive layer 110. In embodiments, the method 400 includes a step 412 of curing the second adhesive layer 110 by exposing an exposed surface 206 of the first transmissive layer 108 to illumination, wherein the illumination transmits through the first transmissive layer 108 to the second adhesive layer 110.

For optical assemblies 100 that include more than one bonding site (e.g., a second surface 212 of the mount 104), the method 400 includes a step of applying a third adhesive layer 200 to a second surface 202 of the optical element 102. In embodiments, the method 400 includes a step of adhering the first surface 206 of the second transmissive layer 204 to the second surface 202 of the optical element 102 via the third adhesive layer 200. In embodiments, the method 400 includes a step of curing the third adhesive layer 200 by exposing the second transmissive layer 204 to illumination, wherein the illumination transmits through the second transmissive layer 204 to the third adhesive layer 200. In embodiments, the method 400 includes a step of applying a fourth adhesive layer 208 to at least one of a second surface 210 of the second transmissive layer 204 or a second surface 212 of the mount 104. In embodiments, the method 400 includes a step of adhering the second surface 210 of the second transmissive layer 204 to the second surface 212 of the mount 104. In embodiments, the method 400 includes a step of curing the fourth adhesive layer 208 by exposing an exposed surface 206 of the second transmissive layer 204 to illumination.

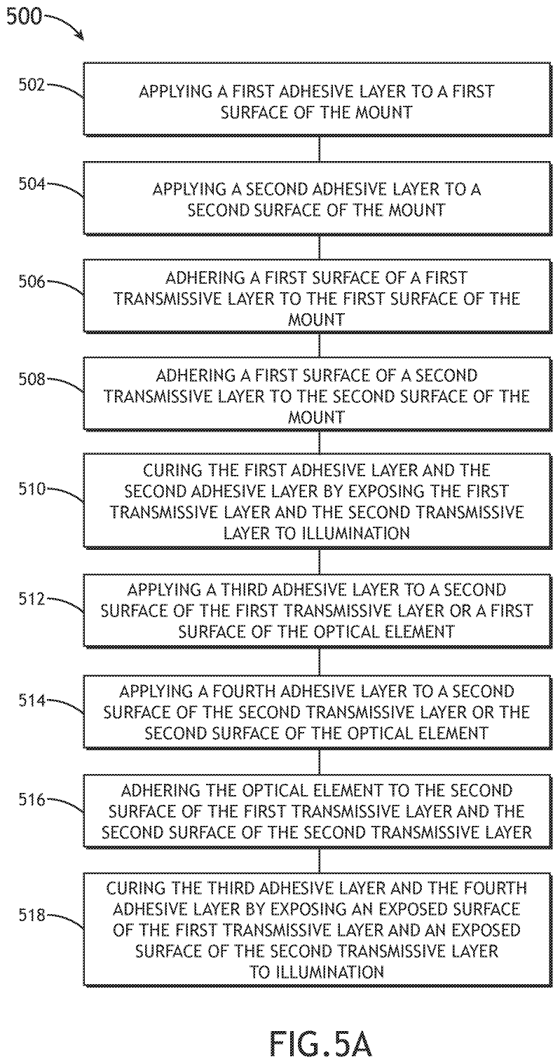

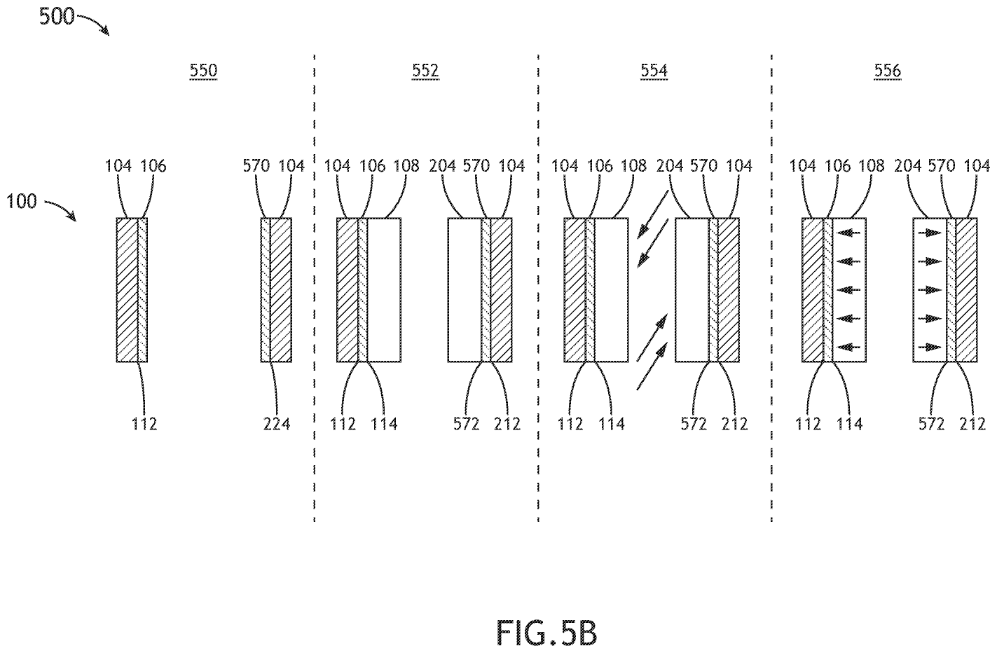

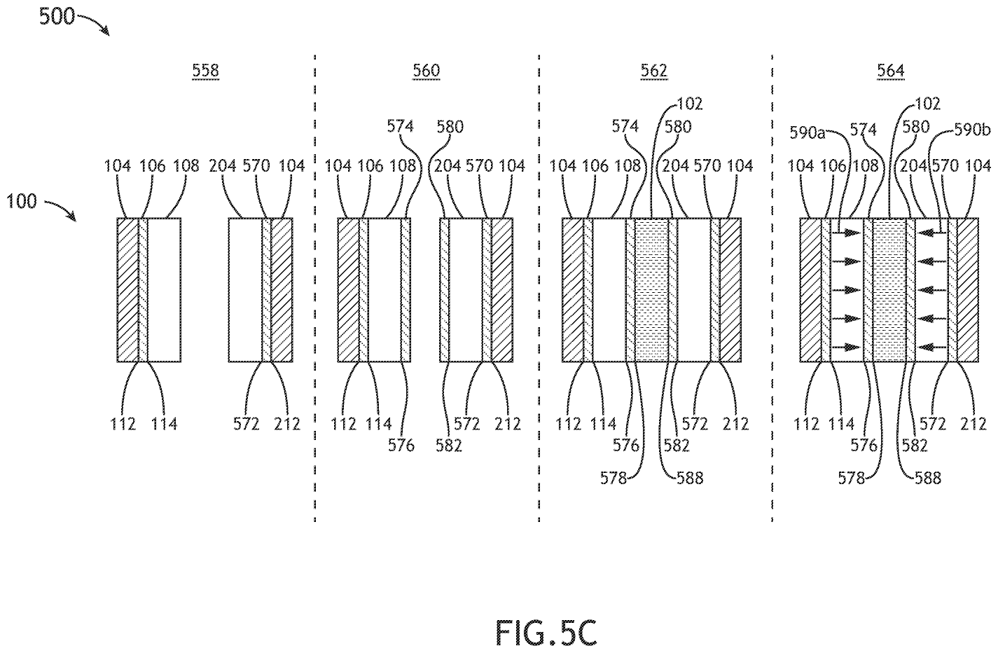

FIG. 5A illustrates a process flow diagram depicting a method 500 of coupling an optical element to two surfaces of a mount, in accordance with one or more embodiments of the disclosure.

FIGS. 5B-5C illustrates views 550, 552, 554, 556, 558, 560, 562, and 564 corresponding to the steps of method 500, in accordance with one or more embodiments of the disclosure. In embodiments, the method 500 includes a step 502 of applying a first adhesive layer to the first surface of a mount. For example, as shown in view 550, the first adhesive layer 106 is applied to the first surface 112 of the mount 104. In embodiments, the method 500 includes a step 504 of applying a second adhesive layer 570 to the second surface 212 of the mount 104.

In embodiments, the method 500 includes a step 506 of adhering a first surface 112 of a first transmissive layer 108 to the first surface 112 of the mount 104 via the first adhesive layer 106. In embodiments, the method 500 includes a step 508 of adhering a first surface 572 of a second transmissive layer 204 to the second surface 212 of the mount 104 via the second adhesive layer 570. Steps 508 and 510 are visualized in view 552 of FIG. 5B.

In embodiments, the method includes a step 510 of curing the first adhesive layer 106 and the second adhesive layer 570 by exposing the first transmissive layer 108 and the second transmissive layer 204 to illumination, wherein the illumination transmits through the first transmissive layer 108 to the first adhesive layer 106; and transmits through the second transmissive layer 204 to the second adhesive layer 570. Step 51 is visualized in views 554, 556, and 558 of FIGS. 5B-5C.

In embodiments, the method 500 includes a step 512 of applying a third adhesive layer 574 to a second surface 576 of the first transmissive layer 108 or a first surface 578 of the optical element 102. In embodiments, the method 500 includes a step 514 of applying a fourth adhesive layer 580 to a second surface 568 of the second transmissive layer 204 or a second surface 588 of the optical element 102. Steps 512 and 514 are visualized in view 560 of FIG. 5C.

In embodiments, the method 500 includes a step 516 of adhering the optical element 102 to the second surface 576 of the first transmissive layer 108 and the second surface 582 of the second transmissive layer 204 via the third adhesive layer 574 and the fourth adhesive layer 580. Step 516 is visualized in view 562 of FIG. 5C.

In embodiments, the method 500 includes a step 518 of curing the third adhesive layer 574 and the fourth adhesive layer 580 by exposing an exposed surface 590a of the first transmissive layer 108 and an exposed surface 590b of the second transmissive layer 204 to illumination, wherein the illumination transmits through the first transmissive layer 108 to the third adhesive layer 574, and through the second transmissive layer 204 to the fourth adhesive layer 580. Step 516 is visualized in view 564 of FIG. 5C.

While implementations of method 400, 500 are discussed herein, it is further contemplated that various steps of method 400, 500 may be included, excluded, rearranged, and/or implemented in many ways without departing from the essence of the present disclosure. For example, the one or more curing steps of methods 400, 500 may be performed simultaneously or sequentially. Accordingly, the foregoing embodiments and implementations of method 400, 500 are included by way of example only and are not intended to limit the present disclosure in any way. It is further contemplated that each of the embodiments of the method described above may include any other step(s) of any other method(s) described herein.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components, and/or wirelessly interactable and/or wirelessly interacting components, and/or logically interacting and/or logically interactable components.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. Furthermore, it is to be understood that the invention is defined by the appended claims.

What is claimed:

1. An optical assembly comprising:
an optical element comprising a first surface;
a mount comprising a first surface;
a first transmissive layer;
a first adhesive layer disposed between a first surface of the first transmissive layer and the first surface of the optical element; and
a second adhesive layer disposed between a second surface of the first transmissive layer and the first surface of the mount, wherein the first transmissive layer is configured to transmit illumination to the first adhesive layer and the second adhesive layer to cure the first adhesive layer and the second adhesive layer.

2. The optical assembly of claim 1, wherein the optical element comprises a second surface, wherein the mount comprises a second surface, the optical assembly further comprising:
a second transmissive layer;
a third adhesive layer disposed between a first surface of the second transmissive layer and the second surface of the optical element; and
a fourth adhesive layer disposed between a second surface of the second transmissive layer and the second surface of the mount wherein the second transmissive layer is configured to transmit illumination to the third adhesive layer and the fourth adhesive layer to cure the third adhesive layer and the third adhesive layer.

3. The optical assembly of claim 1, wherein the optical element comprises at least one of a mirror, a lens, a filter, a prism, or a beam splitter.

4. The optical assembly of claim 1, wherein the first transmissive layer comprises a glass prism.

5. The optical assembly of claim 1, wherein the first transmissive layer is transparent to ultraviolet light.

6. The optical assembly of claim 1, wherein the first adhesive layer and the second adhesive layer are cured via ultraviolet light.

7. An optical system comprising:
an optical assembly comprising:
an optical element comprising a first surface;
a mount comprising a first surface;
a first transmissive layer;
a first adhesive layer disposed between a first surface of the first transmissive layer and the first surface of the optical element; and
a second adhesive layer disposed between a second surface of the first transmissive layer and the first surface of the mount, wherein the first transmissive layer is configured to transmit illumination to the first adhesive layer and the second adhesive layer to cure the first adhesive layer and the second adhesive layer.

8. The optical system of claim 7, wherein the optical system comprises a metrology system.

9. A method for coupling an optical element to a mount comprising:
applying a first adhesive layer to a first surface of the mount;
adhering a first surface of a first transmissive layer onto the first surface of the mount via the first adhesive layer;
applying a second adhesive layer to a second surface of the first transmissive layer;
adhering a first surface of an optical element onto the second surface of the first transmissive layer via the second adhesive layer; and
curing the first adhesive layer and the second adhesive layer by exposing a surface of the first transmissive layer to illumination, wherein the first transmissive layer transmits the illumination to the first adhesive layer and the second adhesive layer.

10. The method of claim 9, further comprising:
applying a third adhesive layer to a second surface of the optical element;
adhering a first surface of a second transmissive layer to the second surface of the optical element via the third adhesive layer;
curing the third adhesive layer by exposing the second transmissive layer to illumination, wherein the illumination transmits through the second transmissive layer to the third adhesive layer;
applying a fourth adhesive layer to at least one of a second surface of the second transmissive layer or a second surface of the mount;
adhering the second surface of the second transmissive layer to the second surface of the mount; and
curing the fourth adhesive layer by exposing an exposed surface of the second transmissive layer to illumination.

11. The method of claim 9, wherein illumination comprises ultraviolet light.

12. The method of claim 9, wherein the first adhesive layer and the second adhesive layer are cured simultaneously.

13. The method of claim 9, wherein the first adhesive layer and the second adhesive layer are cured sequentially.

14. The method of claim 9, wherein the optical element comprises at least one of a mirror, a lens, a filter, a prism, or a beam splitter.

15. The method of claim 9, wherein the first transmissive layer comprises a glass prism.

16. A method for coupling an optical element to a first surface of a mount and a second surface of the mount comprising:
applying a first adhesive layer to the first surface of the mount;
applying a second adhesive layer to the second surface of the mount;
adhering a first surface of a first transmissive layer to the first surface of the mount via the first adhesive layer;
adhering a first surface of a second transmissive layer to the second surface of the mount via the second adhesive layer;
curing the first adhesive layer and the second adhesive layer by exposing the first transmissive layer and the second transmissive layer to illumination, wherein the illumination transmits through the first transmissive layer to the first adhesive layer, and transmits through the second transmissive layer to the second adhesive layer;
applying a third adhesive layer to a second surface of the first transmissive layer or a first surface of the optical element;
applying a fourth adhesive layer to a second surface of the second transmissive layer or the second surface of the optical element;
adhering the optical element to the second surface of the first transmissive layer and the second surface of the second transmissive layer via the third adhesive layer and the fourth adhesive layer; and
curing the third adhesive layer and the fourth adhesive layer by exposing an exposed surface of the first transmissive layer and an exposed surface of the second transmissive layer to illumination, wherein the illumination transmits through the first transmissive layer to the third adhesive layer, and through the second transmissive layer to the fourth adhesive layer.

17. The method of claim 16, wherein illumination comprises ultraviolet light.

18. The method of claim 16, wherein the optical element comprises a mirror.

19. The method of claim 16, wherein the first transmissive layer comprises a glass prism.

20. The method of claim 16, wherein curing the first adhesive layer and the second adhesive layer, and curing the third adhesive layer and the fourth adhesive layer are performed simultaneously.

21. The method of claim 16, wherein curing the first adhesive layer and the second adhesive layer, and curing the third adhesive layer and the fourth adhesive layer are performed sequentially.
